(19) United States
(12) Patent Application Publication
(10) Pub. No.: US 2025/0249301 A1
(43) Pub. Date: Aug. 7, 2025

(54) Method And Device For Preparing To Extinguish Fires

(71) Applicant: Armen Vemirovich Nalbandyan, Rostov-on-Don (RU)

(72) Inventor: Armen Vemirovich Nalbandyan, Rostov-on-Don (RU)

(21) Appl. No.: 18/853,127

(22) PCT Filed: Mar. 28, 2023
(86) PCT No.: PCT/RU2023/000093

§ 371 Date: Sep. 30, 2024

(30) Foreign Application Priority Data
Mar. 31, 2022 (RU) 2022108644

(51) Int. Cl. A62C 27/00

(52) U.S. Cl. CPC A62C 27/00

(57) ABSTRACT

The invention pertains to the field of extinguish. More specifically, it relates to the area of extinguish preparedness.

The method for preparation includes: extinguish equipping an automotive or tractor trailer, or a tractor or universal power unit, or a vehicle performing functions unrelated to extinguish and having the capability to install additional equipment with at least one removable container for storing extinguish agents, as well as a device for applying these extinguish agents; or installing a removable body with at least one container for storing extinguish agents and a device for applying these agents on the chassis of an automotive or tractor trailer, or on the chassis of a tractor or universal power unit, or vehicle that has performed functions unrelated to extinguish and allows for body replacement—after the preliminary dismantling of the main body.

The proposed invention ensures increased efficiency in extinguish preparedness under resource-limited conditions, a reduction in the number of equipment units required in rural areas to address various tasks, an enhancement of the functional capabilities of vehicles or tractors, or their trailers, and an increase in equipment utilization.

### TECHNICAL FIELD

The invention pertains to the field of extinguish. More specifically, it relates to the area of extinguish preparation.

### PRECEDING LEVEL OF TECHNOLOGY

Currently, there is a known method for preparing to extinguish fires in which specialized extinguish equipment, such as fire trucks or fire trailers, is stationed in populated areas (Order of the Ministry of Emergency Situations of the Russian Federation dated Jun. 18, 2003, No. 313 “On Approving the Fire Safety Rules in the Russian Federation (PPB 01-03)” (together with “PPB 01-03 . . . ”) (Registered with the Ministry of Justice of the Russian Federation on Jun. 27, 2003, No. 4838)).

This method is applicable for large cities. However, for rural areas with a low population density, this approach is economically unfeasible, as fire trucks and trailers are expensive.

The task set by the developer of the method and device for preparing to extinguish fires is to create a method and device that would enable the conversion of existing equipment units into fire trucks or fire trailers.

The technical result of the proposed method and device for preparing to extinguish fires is an increase in the efficiency of extinguish readiness under resource-limited conditions, a reduction in the number of equipment units required in rural areas to address various tasks, an enhancement of the functional capabilities of vehicles or tractors, or their trailers, and an increase in equipment utilization.

### DISCLOSURE OF INVENTION

The essence of the method for preparing to extinguish fires is as follows.

An automotive or tractor trailer, or a tractor or universal power unit or vehicle performing functions unrelated to extinguish, is equipped with at least one detachable container for storing extinguish agents, as well as a device for applying these extinguish agents. Alternatively, on the chassis of an automotive or tractor trailer, or on the chassis of a tractor or universal power unit or vehicle that has performed functions unrelated to extinguish and allows for body replacement, a removable body is installed with at least one container for storing extinguish agents, along with a device for applying these extinguish agents-after the preliminary dismantling of the main body.

As a trailer performing functions unrelated to extinguish, a transfer hopper may be used, or the chassis of a transfer hopper may be utilized for installing a removable body.

The essence of the extinguish preparation device is as follows. The extinguish preparation device consists of built-in containers for storing extinguish agents with at least one device for applying these agents, intended for installation on an automotive or tractor trailer, or a tractor or universal power unit, or a vehicle performing functions unrelated to extinguish. Alternatively, a removable body equipped with at least one container for storing extinguish agents and at least one device for applying these agents is designed for installation on an automotive or tractor trailer, or a tractor or universal power unit, or a vehicle performing functions unrelated to extinguish.

### BRIEF DESCRIPTION OF THE DRAWINGS

Invention is illustrated graphically, where:

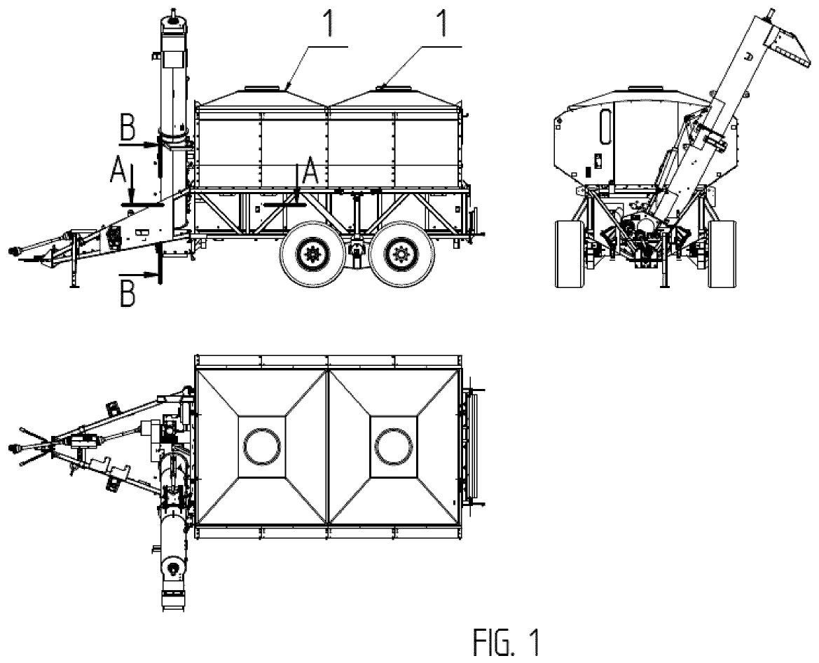

In FIG. 1, a transfer hopper with an integrated extinguish preparation device is shown, where:
1—Container for extinguish agent.

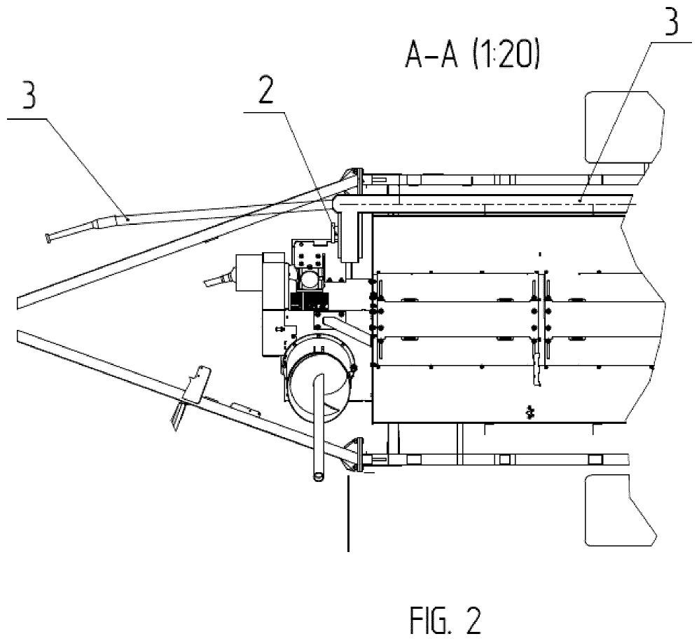

In FIG. 2, a cross-sectional view A-A from FIG. 1 is depicted, where:
2—Pump.
3—Hose.

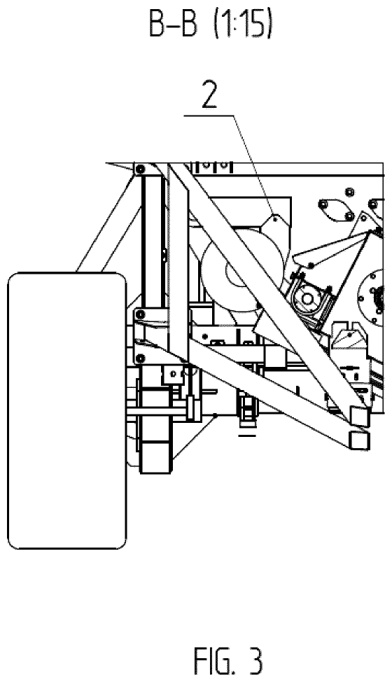

In FIG. 3, a cross-sectional view B-B from FIG. 1 is illustrated, where:
2—Pump.

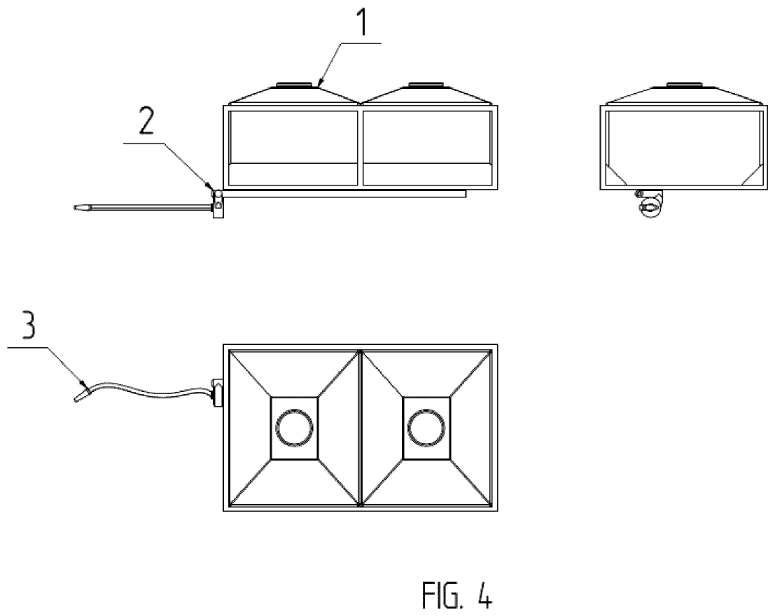

In FIG. 4, the extinguish preparation device for integration is presented, consisting of:
1—Container for extinguish agent.
2—Pump.
3—Hose.

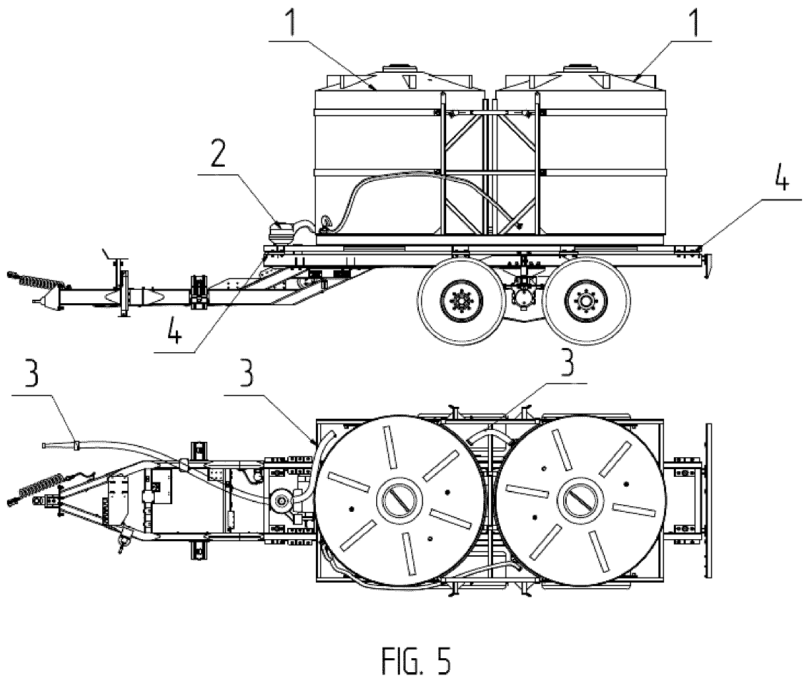

In FIG. 5, a transfer hopper is shown, on which the body has been replaced with a body that serves as a extinguish preparation device, comprising:
1—Container for extinguish agent.
2—Pump.
3—Hose.
4—Mounts for the removable body.

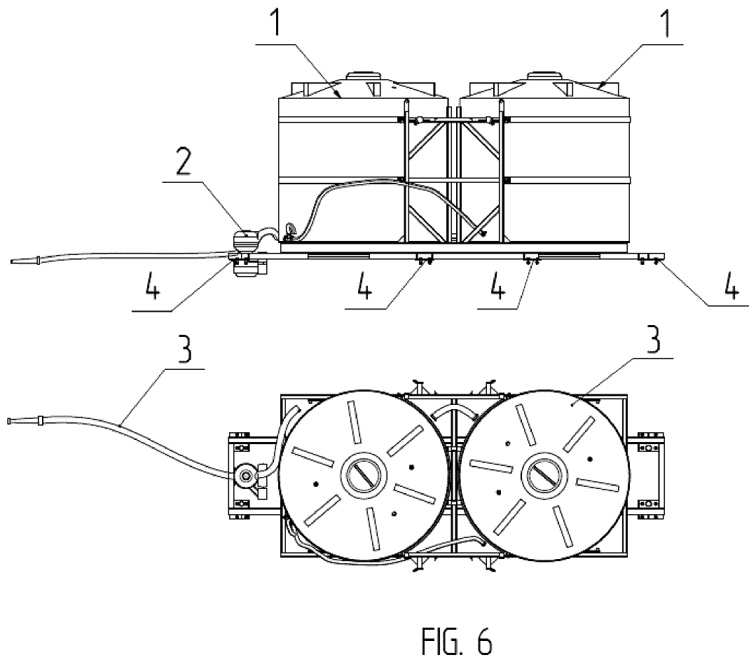

In FIG. 6, the extinguish preparation device is depicted as a removable body, consisting of:
1—Container for extinguish agent.
2—Pump.
3—Hose.
4—Mounts for the removable body.

### EXAMPLE OF A SPECIFIC APPLICATION OF THE INVENTION

The proposed method for preparing to extinguish fires consists of the following. To implement the claimed method, any automotive or tractor trailer, or vehicle, universal power unit, or tractor that does not perform functions related to extinguish and has the capability to install additional equipment may be used. For example, a transfer hopper can be utilized. An example of a transfer hopper is the one offered by the company “Liliani” (https://liliani.ru/product/grain-transfer-trailer/grain-transfer-trailer-16.s2.html). It is equipped with at least one container for storing agents intended for extinguish and at least one device for applying the aforementioned agents, achieved by integrating these devices within the body of the aforementioned unit.

Alternatively, the body of the transfer hopper can be removed, and a body with at least one container for storing extinguish agents and devices for applying these agents can be installed on the chassis of the transfer hopper.

An example of a universal power unit is the HOLMER Terra Variant https://agro-lider.ru/agrotechnics/zashchita-rasteniy-i-udobrenie/holmer-terra-variant/.

Examples of agents intended for extinguish include those known from the prior art, such as water, aqueous solutions of certain salts, water with wetting agents and other additives, water-foam solutions, inert diluents, halons, combined compositions, powders, aerosol compositions, and so on.

Examples of devices for applying extinguish agents include pumps, hoses, foam generators, and other extinguish equipment known from the prior art that can be used to equip a transfer hopper. Pumps can utilize the energy from the tractor, transmitted, for example, through a power take-off shaft or hydraulic pump of the tractor, or from a battery, internal combustion engine (engine-driven pump), electric generator, etc. It will be apparent to a specialist in this field that the selection of devices for applying extinguish agents depends on the choice of the extinguish agent itself.

For example, if water is used as the extinguish agent, then a pump and hose may serve as the devices for applying the extinguish agent. Additionally, a foam generator can be used. If, for instance, the extinguish agent is stored in a pressurized container, then using a hose connected to the aforementioned container may be sufficient as the device for applying the extinguish agent.

If the body of the transfer hopper is removed and a body with at least one container for storing extinguish agents and a device for applying the extinguish agent is installed on the chassis, any known fastening devices from the prior art can be used as mounts. For example, fastenings commonly used to secure containers on railway platforms and container trucks, which are well-known in the art, may be employed.

Similarly, equipment can be installed, or the body can be replaced on any other trailers or vehicles.

The claimed extinguish preparation device in the field consists of at least one built-in container for storing extinguish agents with at least one device for applying these agents, intended for installation on an automotive or tractor trailer, or a tractor or vehicle performing functions unrelated to extinguish. Alternatively, it can be a removable body equipped with at least one container for storing extinguish agents and at least one device for applying these agents, intended for installation on an automotive or tractor trailer, or a tractor or vehicle performing functions unrelated to extinguish.

The aforementioned device, through the integration into an existing body or by replacing the body, enables the conversion of equipment that was originally not intended for extinguish into equipment capable of performing fire suppression.

### INDUSTRIAL APPLICABILITY

Since certain types of equipment, such as agricultural machinery, are used for a limited period, immediately after the completion of agricultural tasks, vehicles, tractors, or their trailers can be converted into fire trucks for the remainder of the year.

Since there is no need to purchase a separate fire truck, the number of equipment units required in rural areas to address various tasks is reduced. As vehicles, tractors, and their trailers are repurposed and not left idle after agricultural work is completed, the functional capabilities of these vehicles, tractors, and/or their trailers are enhanced. Increased utilization of the equipment occurs because the chassis of vehicles or trailers is used even beyond their primary functions originally intended for vehicles, tractors, and trailers.

1. Method for preparing to extinguish fires in which a transfer hopper, capable of accommodating additional equipment, is equipped with at least one removable built-in container for storing extinguish agents, as well as a device for applying these extinguish agents.

2. Method for preparing to extinguish fires in which a removable body with at least one container for storing extinguish agents and a device for applying these agents is installed on the chassis of a transfer hopper that allows for body replacement—after the preliminary dismantling of the main body.
